(19) United States
(12) Patent Application Publication
(10) Pub. No.: US 2006/0146262 A1
(43) Pub. Date: Jul. 6, 2006

(54) Method and the plasma display panel with an improvement of overflow effect of anisotropic conductive adhesive film

(75) Inventors: Chun-Wei Yu, Padeh City Taoyuan (TW); Chi-hsun Li, Padeh City Taoyuan (TW); Kuo-Chuan Huang, Padeh City Taoyuan (TW)

Correspondence Address: BIRCH STEWART KOLASCH & BIRCH, PO BOX 747, FALLS CHURCH, VA, 22040-0747, US

(73) Assignee: Chunghwa Picture Tubes., Ltd

(21) Appl. No.: 11/025,908

(22) Filed: Jan. 3, 2005

(51) Int. Cl. G02F 1/1345

(52) U.S. Cl. 349/149

(57) ABSTRACT

A method to improve the effect of the overflow of the anisotropic conductive film has the steps of providing guide blocks on electrodes of a panel or on a flexible printing circuit (FPC) or on both of them, and then processing a bonding process of the flexible printing circuit (FPC) to melt a conductive film between the flexible printing circuit (FPC) and the panel. The melted conductive film is restricted by the guide blocks to flow to the electrodes and to cover them.

### BACKGROUND OF THE INVENTION

1. Field of the Invention

The present invention relates generally to a plasma display panel, and more particularly to a method of improving the effect of the overflow of an anisotropic conductive film and the plasma display panel thereof.

2. Description of Related Art

For the improvement of the electronic industry, flat panel displays (FPD) are broadly applied to electronic products. The plasma display panel (PDP) is one of the flat panel displays, which has a potential development. The conventional backend process of the plasma panel display, which is the bonding process of the flexible printing circuit (FPC) as shown in FIG. 1, mostly applies an anisotropic conductive film (ACF) as the media to bond the flexible printing circuit 1 to the panel 2. Therefore, the flexible printing circuit 1 becomes electrical connections among the panel 2 and printed circuit boards. Aforesaid structure is taught in U.S. Pat. No. 6,472,820 “Plasma display panel” and U.S. Pat. No. 6,522,073 “Plasma display panel with an auxiliary bonding pad”.

As shown in FIG. 2, the anisotropic conductive film (ACF) is mainly made of thermo material, such as epoxy resin or polyethylene and is made into a roll. The anisotropic conductive film (ACF) has a plurality of conductive particles 4 (Ni, especially a gold-plated Ni with a diameter of 6˜8 μm) to be softened by bonding process and to attach and electrically connect the flexible printing circuit 1 to the panel 2 and also achieving an effect of vertical electrical-connection between the flexible printing circuit 1 and electrodes 5, 6 of the panel 2.

As shown in FIG. 3, a flexible printing circuit 1 bonded on a panel 2 and melted anisotropic conductive film 3 is squeezed out, so the overflow of the anisotropic conductive film can be found on the edge after bonding. While the bonding process has finished and the flexible printing circuit is found that is bonded at an incorrect position, it might cause some silver electrodes exposed and the silver electrodes might have migration. This will reduce the life of the plasma display panel. If the overflow of the anisotropic conductive film can fully cover silver electrodes of the panel 2, it will protect the silver electrodes of the panel 2 and extend the life of the plasma display panel.

Until now, there is no invention teaching a method to guide the melted anisotropic conductive film flowing to cover the silver electrodes of the panel.

### SUMMARY OF THE INVENTION

The primary objective of the present invention is to provide a method, which the anisotropic conductive film can be guided to flow to the silver electrodes of the panel and to cover them, such that the anisotropic conductive film protects the panel to prolong the life of the plasma display panel.

To achieve the objective of the present invention, a method of improving effect of overflow of anisotropic conductive film is provided. The anisotropic conductive film is used for connecting the electrodes of the flexible printing circuit and the panel during bonding process. The method comprises the steps of: providing guide blocks between electrodes on a panel, and than processing a bonding process of the flexible printing circuit (FPC) to melt a conductive film between the flexible printing circuit (FPC) and the panel. The melted conductive film is restricted by the guide blocks to flow to the electrodes and cover them.

In addition, the invention provides another method comprising the steps of: providing guide blocks on the electrodes of a flexible printing circuit (FPC) and than processing a bonding process of the flexible printing circuit (FPC) to melt a conductive film between the flexible printing circuit (FPC) and the panel. The melted conductive film is restricted by the guide blocks to flow to the electrodes and cover them.

Moreover, the invention further provides another method comprising the steps of: providing guide blocks between electrodes on a panel and the electrodes of a flexible printing circuit (FPC), and than processing a bonding process of the flexible printing circuit (FPC) to melt a conductive film between the flexible printing circuit (FPC) and the panel. The melted conductive film is restricted by the guide blocks to flow to the electrodes and cover them.

### BRIEF DESCRIPTION OF THE DRAWINGS

FIG. 1 a 3D view of the conventional bonding process of flexible printing circuit, showing the relation of a panel and a flexible printing circuit (FPC) during bonding process;

FIG. 2 a schematic view of the conventional bonding process of flexible printing circuit, showing the relation of the panel, the flexible printing circuit (FPC), and the anisotropic conductive film (ACF) before bonding process;

FIG. 3 a schematic view of the conventional bonding process of flexible printing circuit, showing the relation of the silver electrodes of the panel, the flexible printing circuit (FPC), and the anisotropic conductive film (ACF) after bonding process;

FIG. 4 is a schematic view of the silver electrodes and the guide blocks of the first preferred embodiment of the present invention;

FIG. 5 is a schematic view of the first preferred embodiment of the present invention referring A-A section of FIG. 4;

FIG. 6 is a schematic view of the first preferred embodiment of the present invention, showing the anisotropic conductive film (ACF) flowing to the silver electrodes of the panel;

FIG. 7 is a schematic view of the first preferred embodiment of the present invention, showing the silver electrodes of the panel, the flexible printing circuit (FPC) and the guide blocks after bonding process;

FIG. 8 is a schematic view of the copper electrodes of the flexible printing circuit (FPC) and the guide blocks of the second preferred embodiment of the present invention;

FIG. 9 is a schematic view of a second preferred embodiment of the present invention referring B-B section of FIG. 8; and

FIG. 10 is a schematic view of a third preferred embodiment of the present invention, showing the silver electrodes, the FPC and the guide blocks.

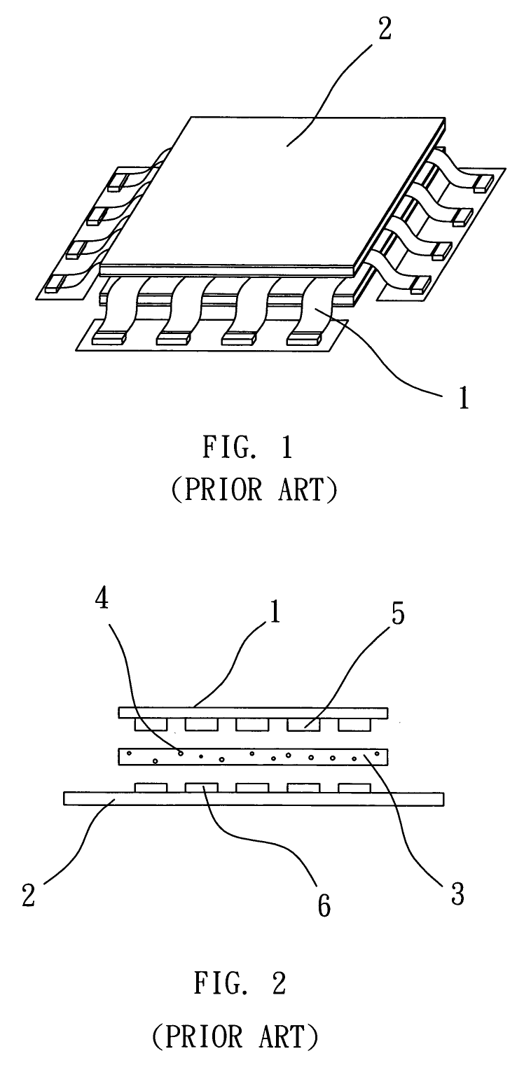

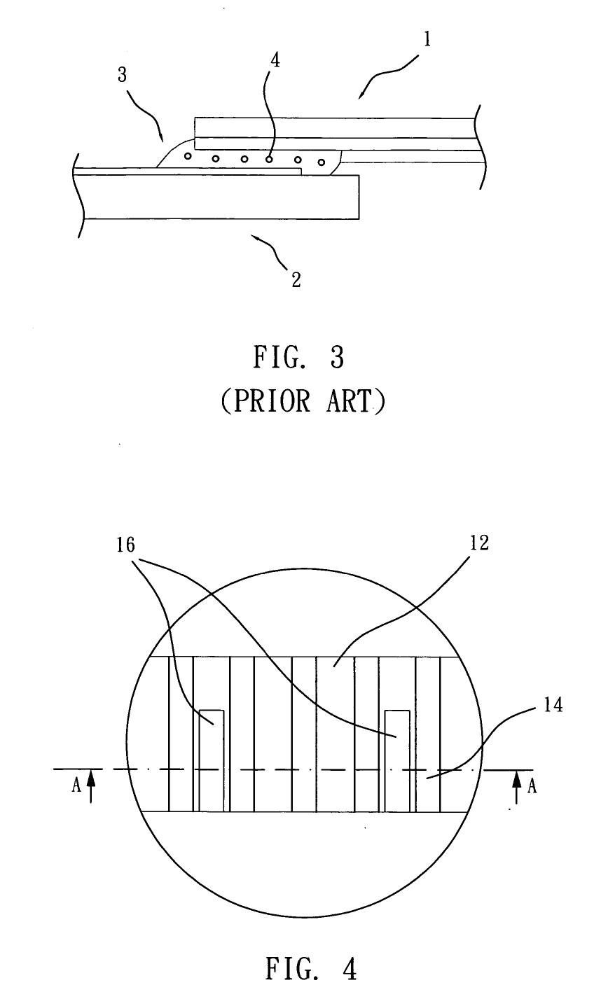

### DETAILED DESCRIPTION OF THE INVENTION

A method of the present invention applies the backend process of plasma display panel (PDP), which is the bonding process of the flexible printing circuit (FPC) to improve the overflow condition of an anisotropic conductive film (ACF), and guiding the overflow of the anisotropic conductive film to prolong the life of plasma display panel.

### First Embodiment

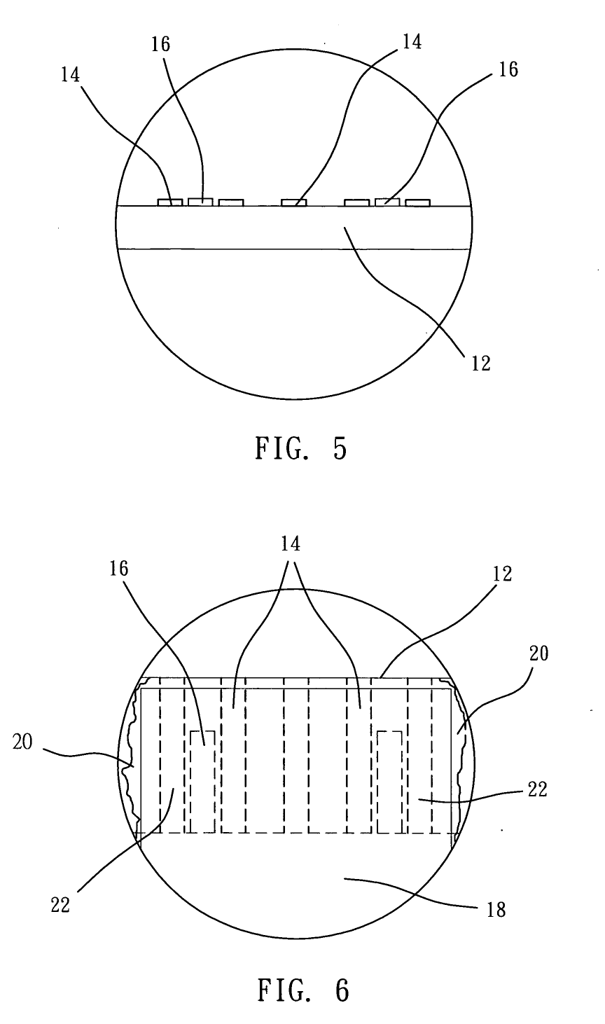

As shown in FIG. 4 and FIG. 5, a method of the first preferred embodiment comprises the steps of that provides a plurality of parallel guide blocks 16 on a panel 12 between silver electrodes 14, such as address electrodes. The guide blocks 16 are elongated walls printed on between the silver electrodes 14 with a predetermined thickness and length respectively. The elongated orientations of the guide blocks 16 are parallel to axes of the silver electrodes 14 respectively.

As shown in FIG. 6, processing a bonding process of a flexible printing circuit (FPC) 18. The bonding process has the steps of that place an anisotropic conductive film 20 between the silver electrodes 14 of the panel 12 and the electrodes 22 of the flexible printing circuit (FPC) 18. (The electrodes 22 are a gold-plated copper electrode. In addition, the electrodes of the roll flexible printing circuit (FPC) are a solder plated copper electrode.) Use hot bond to melt an anisotropic conductive film 20, the melted anisotropic conductive film (ACF) 20 flows to the silver electrodes 14 via the guide blocks 16 and covers the silver electrodes 14. And then, wait for solidification.

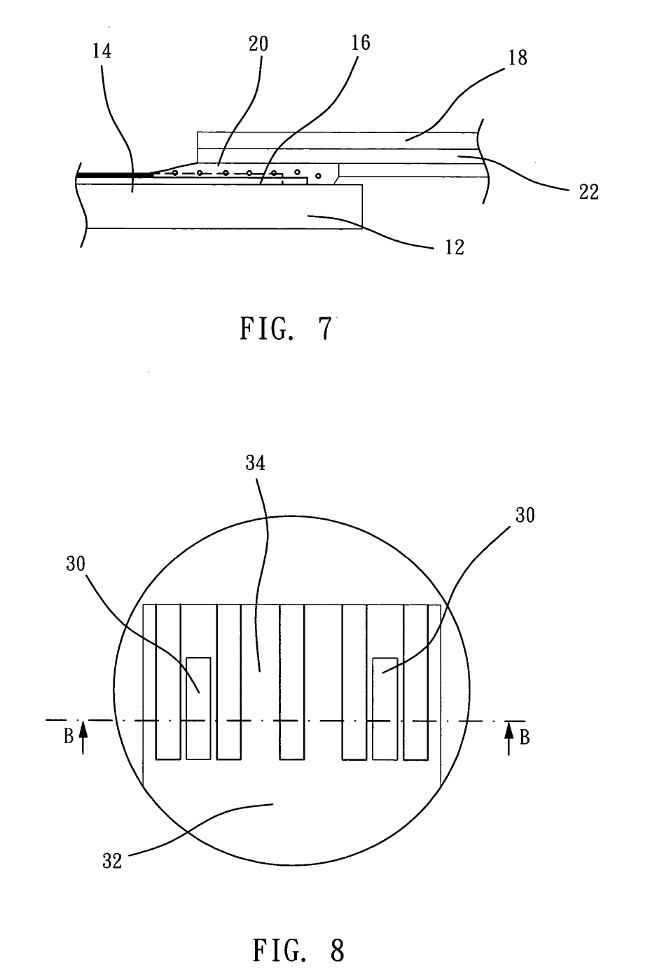

As shown in FIG. 7, a method of the present invention uses the overflow of the anisotropic conductive film 20 and guides it flowing to the silver electrodes 14 via the guide blocks 16 to cover the silver electrodes 14. The anisotropic conductive film 20 protects the silver electrodes 14 of the panel 12 for moisture-proof that prolong the life of the plasma display panel (PDP).

### Second Embodiment

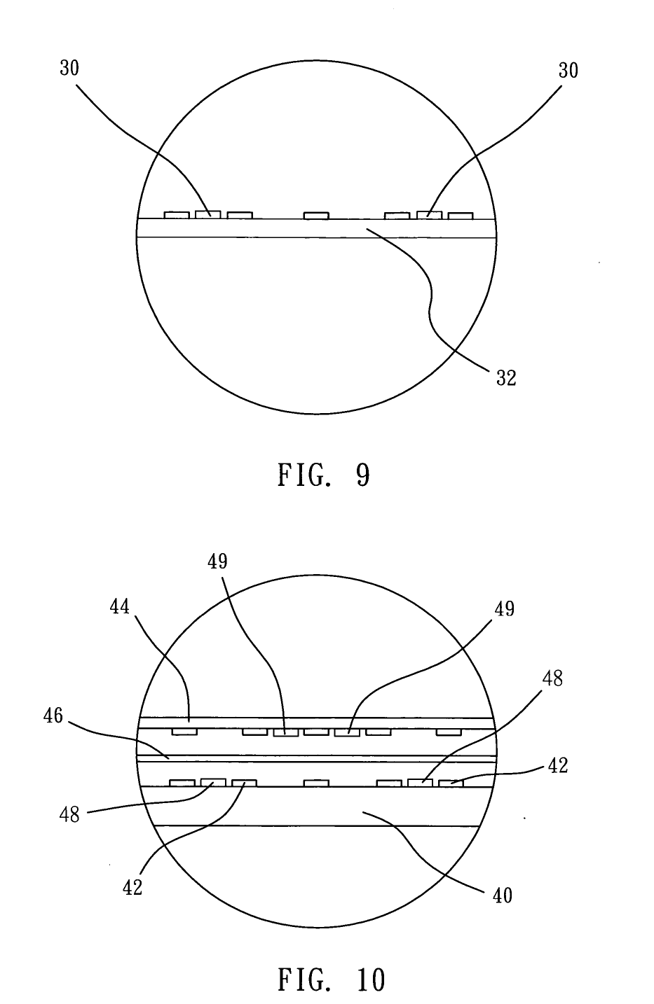

As shown in FIG. 8 and FIG. 9, the second preferred embodiment provides guide blocks 30 on electrodes 34 of a flexible printing circuit (FPC) 32 and elongated orientations of the guide blocks 30 are parallel to silver electrodes of a panel (not shown).

Therefore, while hot bonding an anisotropic conductive film, it still can cover the silver electrodes of a panel and serve the function as same as the first preferred embodiment.

### Third Embodiment

As shown in FIG. 10, a method of the third preferred embodiment provides guide blocks 48 between silver electrodes 42 on a panel 40 and guide blocks 49 on a flexible printing circuit (FPC) 44 respectively to guide the flow of a melted conductive film 46. It also has the functions of protecting the silver electrodes 42 and prolonging the life of the plasma display panel (PDP).

In conclusion, the present invention provides the method applied to the backend process of the plasma display panel (PDP). The method uses the overflow of the conductive film after the bonding process and provides the guide blocks between silver electrodes on the panel or on the electrodes of the flexible printing circuit (FPC) or on both of them to guide the flow of the overflow of the conductive film to cover the silver electrodes. This will protect the silver electrodes of the panel and prolong the life of the plasma display panel (PDP).

The guide blocks of the present invention should not be restricted to any specific shape, orientation, position and size. The one who serves the function of guiding the flow of the conductive film and increasing the overflow of the conductive film, which means that the conductive film has more portions to cover the silver electrodes, is the scope of the present invention.

What is claimed is:

1. A method of improving effect of overflow of anisotropic conductive film on the bonding process of the flexible printing circuit of the plasma display panel, comprising the steps of:
providing an anisotropic conductive film for connecting electrodes of a flexible printing circuit and a panel; and
providing guide blocks between said electrodes on said panel, and than processing a bonding process of said flexible printing circuit to melt said anisotropic conductive film between said flexible printing circuit and said panel, wherein the melted anisotropic conductive film is restricted by said guide blocks to flow to said electrodes and cover them.

2. The method as defined in claim 1, wherein said anisotropic conductive film contains a plurality of conductive particles which can electrically connect said electrodes of said panel and said electrodes of said flexible printing circuit.

3. The method as defined in claim 1, wherein said guide blocks are an elongated walls having a predetermined thickness and length.

4. The method as defined in claim 1, wherein said guide blocks are provided along axes of said electrodes.

5. The method as defined in claim 4, wherein said guide blocks are printed.

6. A method of improving effect of overflow of anisotropic conductive film on the bonding process of the flexible printing circuit of the plasma display panel, comprising the steps of:
providing an anisotropic conductive film for connecting electrodes of a flexible printing circuit and a panel; and
providing guide blocks on a flexible printing circuit, and than processing a bonding process of the flexible printing circuit to melt a conductive film between the flexible printing circuit and a panel, wherein said melted conductive film is restricted by the guide blocks to flow to electrodes of the panel and cover them.

7. The method as defined in claim 6, wherein said anisotropic conductive film contains a plurality of conductive particles which can electrically connect said electrodes of said panel and said electrodes of said flexible printing circuit.

8. The method as defined in claim 6, wherein said guide blocks are an elongated walls having a predetermined thickness and length.

9. The method as defined in claim 6, wherein said guide blocks are provided along axes of said electrodes.

10. The method as defined in claim 9, wherein said guide blocks are printed.

11. A method of improving effect of overflow of conductive film on the bonding process of the flexible printing circuit of the plasma display panel, comprising the steps of:
providing an anisotropic conductive film for connecting electrodes of a flexible printing circuit and a panel; and
providing guide blocks between electrodes on a panel and on a flexible printing circuit, and than processing a bonding process of the flexible printing circuit to melt a conductive film between said flexible printing circuit and said panel, wherein the melted conductive film is restricted by said guide blocks to flow to said electrodes of said panel and cover them.

12. The method as defined in claim 11, wherein said anisotropic conductive film contains a plurality of conductive particles which can electrically connect said electrodes of said panel and said electrodes of said flexible printing circuit.

13. The method as defined in claim 11, wherein said guide blocks are an elongated wall-like element having a predetermined thickness and length.

14. The method as defined in claim 11, wherein said electrodes of said panel are parallel to said guide blocks of said flexible printing circuit.

15. The method as defined in claim 14, wherein said guide blocks are provided along axes of said electrodes.

16. The method as defined in claim 15, wherein said guide blocks are printed on said electrodes.

17. A plasma display panel by improving effect of overflow of anisotropic conductive film has a characteristic of: guide blocks are set on between electrodes of said panel.

18. A plasma display panel by improving effect of overflow of anisotropic conductive film has a characteristic of: guide blocks are set on said flexible printing circuit.

19. A plasma display panel by improving effect of overflow of anisotropic conductive film has a characteristic of: guide blocks are set on between electrodes of said panel and on said flexible printing circuit.
